(19) United States
(12) Patent Application Publication
(10) Pub. No.: US 2012/0218550 A1
(43) Pub. Date: Aug. 30, 2012

(54) NANOHOLE ARRAY BIOSENSOR

(75) Inventor: Joseph O'Mahony, Waterford (IE)

(73) Assignee: WATERFORD INSTITUTE OF TECHNOLOGY, Waterford (IE)

(21) Appl. No.: 13/503,902

(22) PCT Filed: Oct. 5, 2010
(86) PCT No.: PCT/EP10/64862

§ 371 Date: Apr. 25, 2012

(30) Foreign Application Priority Data
Nov. 5, 2009 (IE) S2009/0855

(51) Int. Cl. G01N 21/59; B23P 17/04; G01N 21/01

(52) U.S. Cl. 356/432; 356/244; 29/527.2

(57) ABSTRACT

A biosensor includes a light transmissive optical component (18) comprising a plurality of optical fibres fused side-by-side, the fibres extending between and terminating at opposite faces of the component for transmission of light through the component. A gold film (20) is coated on one face of the optical component, and a plurality of nanohole arrays are formed in the gold film.

This application is a 35 USC 371 national phase filing of PCT/EP2010/064862 filed Oct. 5, 2010, which claims priority to Irish patent application S2009/0855 filed Nov. 5, 2009, the disclosures of which are incorporated herein by reference in their entireties.

### TECHNICAL FIELD

This invention relates to a nanohole array biosensor, and a biosensing apparatus including such a sensor.

### BACKGROUND

W. L. Barnes, A. Dereux, T. W. Ebbesen, Nature 24 (2003) 824-830 (incorporated herein by reference) discloses extraordinary optical transmission (EOT) through sub-wavelength apertures where visible light, normally incident on a metal film containing a periodic array of sub-wavelength nanoholes, exhibits a peak transmission intensity which is orders of magnitude higher than had been predicted previously. The nanohole arrays were fabricated in an optically thick gold film deposited on a glass substrate using a focused ion beam milling.

A short ordered array of nanoholes acts in a similar way to a periodic grating allowing the incident radiation to stimulate surface plasmon modes of a characteristic frequency that depends on the dielectric function of the metal, the periodicity of the hole array and the dielectric function of medium at the surface of the metal film. The process by which light transfers through the hole depends on the thickness of the metal film.

For optically thick films, where the thickness is too great to allow plasmon/plasmon coupling between the two sides of the film, the process involves evanescent waves tunnelling down through the aperture walls resulting in a small amplitude of light at the emission side, for example, as disclosed by A. Kishnihan, T. Thio, T J. Kima, H. J. Lezec, T. W. Ebbesen, P. A. Wolff, J. Pendry, L. Martin Moreno, F. J. Garcia-Vidal, Opt. Commun 200(2001) 1-7, which are incorporated herein by reference in their entireties. At this point the plasmons recouple to the metallic film on the opposite side and their associated fields interfere resulting in the propagation of light.

For optically thin metal films where there is considerable plasmon/plasmon overlap the light emission is greatly enhanced.

P. R. H. Strark, A. E. Halleck, D. N. Larson, Methods 37 (2005) 37-47 (incorporated herein by reference) discloses the application of nanohole plasmons in the area of biosensing. This involves a sensing method for detecting a refractive index change through the variation in light intensity transmitted through nanohole structures fabricated on a gold film. The nanohole structures were fabricated in an optically thick film using a focused ion beam to produce an array of holes with a periodicity of 500 nm.

Separately, A. Dahlin, M. Zach, T. Rindzevicius, M. Kall, D. S. Sutherland, F. Hook J. Am. Chem. Soc. 127(2005) 5043-5048 (incorporated herein by reference) discloses the suitability of EOT for biosensing. In their experiments nanoholes were fabricated randomly in an optically thin film of gold and a biotin/neutravidin immunoassay concept was demonstrated. In both cases, the biosensor was based on the transmission of light through a periodic array of nanoholes fabricated on a standard microscope glass slide.

J. C. Yang, J. Ji, J. M. Hogle, D. N. Larson Biosensors and Bioelectronics, 24(2009), 2334-2338 (incorporated herein by reference) discloses constructing up to 25 independent nanohole arrays of different periodicities within a 60 μm×50 μm area on a single substrate for multiplexed plasmonic sensing.

A. Dhawan, J. F. Muth Materials Science and Engineering: B, 149(3), (2008), 237-241 (incorporated herein by reference) discloses arrays of nanoholes constructed at the tips of individual single mode and multimode optical fibres and demonstrated their feasibility for fibre optic sensing.

Surface plasmons (SP's) are refractive index sensitive charge density oscillations occurring on metal surfaces. Conveniently stimulated with light via suitable coupling mechanisms that increase the momentum of the incident light to satisfy the plasmon dispersion relation, they have been successfully deployed in a number of commercial instruments as a method of investigating chemical and biochemical interactions. As disclosed in U.S. Pat. No. 6,441,904 and US 2006/0108219, which are incorporated herein by reference in their entireties, these instruments typically employ prisms, waveguides or gratings to increase the momentum of light incident on a continuous metal surface containing a layer of receptive molecules acting as a dielectric medium. Their sensitivity to changes in the refractive index around the interface of the metal and dielectric results in changes the angular distribution, reflected spectra or reflected intensity of the light. The measurement of which provides a label free measurement of ligand-receptor binding for chemical and biochemical assays.

These methods of plasmon resonance detection do not lend themselves easily to high throughput screening applications where multiple individual assays are recorded at the one time.

### SUMMARY OF THE INVENTION

The present invention provides a biosensor including a light transmissive optical component comprising a plurality of optical fibres fused side-by-side, the fibres extending between and terminating at opposite faces of the component for transmission of light through the component, a metallic film coated on at least part of one face of the optical component, and a plurality of nanohole arrays formed in the metallic film.

Preferably the one face of the optical component is formed with a plurality of depressions and a respective metallic film nanohole array is formed in at least some of the depressions.

The invention further provides a method of making a biosensor including providing a light transmissive optical component comprising a plurality of optical fibres fused side-by-side, the fibres extending between and terminating at opposite faces of the component for transmission of light through the component, coating a metallic film on at least part of one face of the optical component, and a forming plurality of nanohole arrays in the metallic film.

The invention further provides a biosensing apparatus comprising a biosensor as specified above, a source of monochromatic light at a given wavelength for illuminating the nanohole arrays, and processing means for processing signals output from the light sensing array, wherein the nanoholes have sub-wavelength dimensions and the metallic film has at least one hole with a super-wavelength dimension.

### BRIEF DESCRIPTION OF THE DRAWINGS

Embodiments of the invention will now be described, by way of example, with reference to the accompanying drawings, in which:

FIG. 1 is a schematic diagram of a conventional arrangement for measuring EOT.

FIG. 2 is a schematic side view of an embodiment of a biosensor according to the invention.

FIG. 3 is a schematic diagram of a biosensing apparatus incorporating a biosensor as seen in FIG. 2.

### DETAILED DESCRIPTION OF THE EMBODIMENT

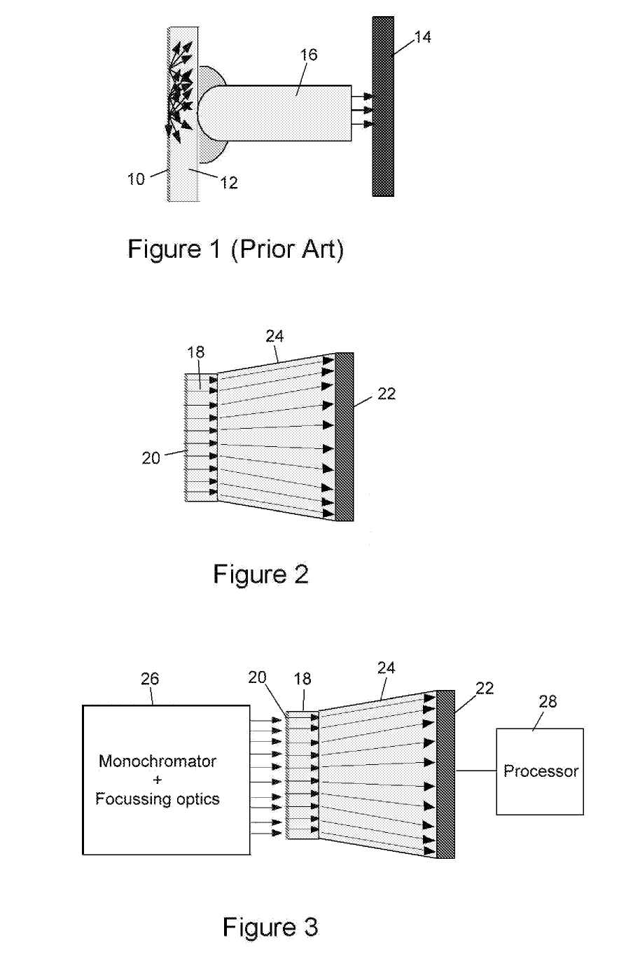

FIG. 1 shows a prior art nanohole array biosensing apparatus for measuring EOT. A plurality of sub-wavelength nanohole arrays is formed in a gold film 10 coated on a glass slide 12. The gold film 10 is illuminated with monochromatic light and the light transmitted through the slide 12 is focussed on a CDD detector (light sensing array) 14 by an oil immersion lens 16. In use a small quantity of a biological analyte is placed on each nanohole array and the intensity of light sensed by the CCD detector in respect of each nanohole array is analysed in a known manner to provide information about the sample. A disadvantage of this apparatus is that light scattering at the interface of the nanohole film and the glass slide reduces the efficiency of light transfer to the CCD detector.

FIG. 2 shows an embodiment of biosensor according to the invention. The biosensor includes a fibre optic faceplate 18, for example of the type produced by Schott North America, Inc., Elmsford, N.Y. 10523, USA. The faceplate 18 comprises a plurality of parallel optical fibres fused side-by-side, the fibres extending perpendicularly between and terminating at opposite parallel major surfaces of the faceplate to form an optically transparent plate that allows the 1:1 transmission of light from one major surface of the plate to the other. Preferably, each optical fibre has a core diameter of greater than 6 microns and the fused faceplate is preferably larger than 1 cm² in area, most preferably up to 15 cm×15 cm in size corresponding to the size of a conventional micro well plate.

In a first embodiment, each major surface of the faceplate 18 is polished flat and smooth with no additional structures other than the nanohole arrays to be formed on one of them.

In a second embodiment, one major surface of the faceplate 18 is provided with a matrix of circular depressions or wells that accommodate the nanohole arrays and, in use, the analytes to be tested. Preferably, the series of wells are fabricated using powder blasting such as provided by Anteryon BV, Eindhoven, The Netherlands. The faceplate 18 may comprise up to 1536 individual wells in a rectangular matrix, each well accommodating up to 1 ml of liquid. For example, each well could be up to 2 mm deep and 0.5 cm² in area.

One major surface of the faceplate 18 is at least partially coated with a film 20 of gold. The film 20 has a thickness less than 100 nm, preferably a thickness less than 80 nm, and most preferably a thickness of from 10 nm to 14 nm. As discussed above, layers thicker than 100 nm are optically thick and do not exhibit EOT. Where the faceplate 18 is provided with wells on one major surface, the gold film is deposited on that surface, at least within the wells.

A plurality of rectangular arrays of nanoholes are formed in the gold film 20. Where the faceplate 18 has wells the arrays of nanoholes are formed on the gold film within the wells, at least the majority of the wells containing a respective array acting as an individual sensor (some wells may contain larger holes, as will be described). The nanohole arrays may be manufactured by electron beam or soft colloidal lithography techniques such as described in “Colloidal lithography and current fabrication techniques producing in-plane nanotopography for biological applications”, M A Wood, J R Soc Interface (2007) 4, 1-17, 23 Aug. 2006.

The nanoholes are preferably circular and have sub-wavelength diameters, typically in the range of 80 nm to 200 nm but in any event preferably less than 500 nm. By “sub-wavelength” we mean that the diameter of the nanoholes is less than the wavelength of light used to illuminate the arrays in use. Each array has a periodicity P that is an integer multiple of the diameter of the nanoholes:

P=d(1+n)

where d is the diameter of the nanohole and n preferably has an integer value between 0 and 4. The periodicity of the nanoholes is preferably no greater than 2.5 microns.

Provided they meet the above requirements, it is not necessary that all the arrays have the same nanohole diameter or array periodicity, and they need not be rectangular arrays although they should be regular. Also, the nanoholes need not be circular, in which case d above refers to their maximum dimension.

In addition to the sub-wavelength nanoholes, a number super-wavelength holes are formed in the gold film in at least some of the wells (where wells are present), and these will have diameters or maximum dimensions at least ten times greater than the nanoholes, typically greater than 1.6 microns. As the faceplate 18 allows light to pass directly through these super-wavelength holes, they act as blanks which can be used to determine the intensity of light incident on adjacent nanoholes so enabling sensing circuitry to determine a baseline for light being transmitted through the adjacent nanoholes and so improve signal to noise ratio in later processing.

The major surface of the faceplate 18 opposite that bearing the gold film is coupled to a CCD detector 22 via a fibre optic taper 24 which is bonded to the CCD detector. CCD detectors can be from 20×20 mm to 100×100 mm in area and include up to 8192×8192 pixels; the taper 24 can either widen or narrow from the detector 22 to the faceplate 18 to compensate for the difference in area between the faceplate 18 and the detector. The taper acts as a waveguide to transmit the light from the sensor directly to the CCD pixels. E2V Technologies plc, of Chelmsford, Essex CM1 2QU, United Kingdom supply CCD sensors with fibre optic tapers attached. The fused fibre faceplate 18 can interface with the CCD/taper assembly through an optical gel with the two components then spring-coupled together.

The fibre optic faceplate 18 has high numerical aperture for direct collection of the transmitted light, the numerical aperture being close to 1 for the both the CCD taper and the fibre optic faceplate. Binning or merging of individual pixels to form a super pixel creates an optical detector of sufficient size to collect of light from a single set of sensor arrays forming the actual sensor.

Preferably, single wavelength light from a monochromator 26, FIG. 3, is focussed directly on the gold film 20 on the faceplate 18. The transmission spectrum is recorded by the CCD detector 22 for each nanohole array. In this case the peak transmission wavelength is determined by processing circuitry 28 which processes signals output from the CCD detector. The peak transmission wavelength is related to the periodicity of the nanohole array, the dielectric function of the gold film and the dielectric function of the analyte contacting the film according to the following equation:

$${λ}_{ma x} = \frac{P}{v} \sqrt{\frac{{ɛ}_{m} {ɛ}_{d}}{{ɛ}_{m} + {ɛ}_{d}}}$$

where v is the order of diffraction and P is the periodicity of the grating.

An alternative arrangement allows broadband radiation to directly illuminate the sensor. In this case the change in amplitude of the transmitted signal is measured.

In other embodiments the faceplate 18 may be directly optically coupled to the CCD detector 22 (i.e. the taper 24 omitted) if the areas of the two components are compatible, and the faceplate itself may incorporate a slight taper. Alternatively, the gold film 20 and nanohole arrays may be formed directly on the taper 24, omitting the faceplate 18.

Although the film 20 has been made of gold in the embodiments, other metallic films may be used, such as silver, platinum and palladium.

The invention is not limited to the embodiments described herein which may be modified or varied without departing from the scope of the invention.

1. A biosensor including a light transmissive optical component comprising a plurality of optical fibres fused side-by-side, the fibres extending between and terminating at opposite faces of the component for transmission of light through the component, a metallic film coated on at least part of one face of the optical component, and a plurality of nanohole arrays formed in the metallic film.

2. A biosensor as claimed in claim 1, wherein the optical fibres extend substantially parallel to one another between the opposite faces of the optical component.

3. A biosensor as claimed in claim 1, wherein the optical fibres converge between the opposite faces of the optical component.

4. A biosensor as claimed in claim 1, wherein the component is a plate with the opposite faces being opposite substantially parallel surfaces of the plate.

5. A biosensor as claimed in claim 1, wherein the maximum dimension d of the nanoholes is less than 500 nm, preferably from 80 nm to 200 nm.

6. A biosensor as claimed in claim 1, wherein each array has a periodicity of d(1+n) where d is the maximum dimension of the nanoholes and n has a value from 0 to 4.

7. A biosensor as claimed in claim 1, wherein the thickness of the metallic layer is less than 100 nm, preferably less than 80 nm, and most preferably from 10 nm to 14 nm.

8. A biosensor as claimed in claim 1, wherein the metallic layer has at least one hole whose maximum dimension is at least ten times as large as the maximum dimension of the nanoholes.

9. A biosensor as claimed in claim 1, wherein the one face of the optical component is formed with a plurality of depressions and a respective metallic film nanohole array is formed in at least some of the depressions.

10. A biosensor as claimed in claim 9, wherein each depression is up to 2 mm deep.

11. A biosensor as claimed in claim 9, wherein each depression is up to 0.5 cm² in area.

12. A biosensor as claimed in claim 1, wherein the metallic film comprises gold.

13. A biosensor as claimed in claim 1, wherein the other face of the optical component is optically coupled to a light sensing array.

14. A biosensor as claimed in claim 13, wherein the other face is directly coupled to the light sensing array.

15. A biosensor as claimed in claim 13, wherein the other face is indirectly coupled to the light sensing array via a fibre optic taper to at least partially compensate for a difference in the area between the other face and the area of the sensing array.

16. A method of making a biosensor including providing a light transmissive optical component comprising a plurality of optical fibres fused side-by-side, the fibres extending between and terminating at opposite faces of the component for transmission of light through the component, coating a metallic film on at least part of one face of the optical component, and a forming plurality of nanohole arrays in the metallic film.

17. A method as claimed in claim 16, wherein the one face of the optical component is formed with a plurality of depressions and a respective metallic film nanohole array is formed in at least some of the depressions.

18. A biosensing apparatus comprising a biosensor as claimed in claim 13, a source of monochromatic light at a given wavelength for illuminating the nanohole arrays, and processing means for processing signals output from the light sensing array, wherein the nanoholes have sub-wavelength dimensions and the metallic film has at least one hole with a super-wavelength dimension.
